(19) United States
(12) Patent Application Publication
(10) Pub. No.: US 2005/0005280 A1
(43) Pub. Date: Jan. 6, 2005

(54) Optical disc drive with elastic dampeners

(76) Inventor: Xian-ging You, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/884,335

(22) Filed: Jul. 1, 2004

(30) Foreign Application Priority Data
Jul. 1, 2003 (CN) 03267229.2

(51) Int. Cl. G11B 7/085

(52) U.S. Cl. 720/659; 720/672

(57) ABSTRACT

An optical disc drive (99) includes a frame (2); a U-shaped subframe (4) pivotably mounted on the frame; a slider (3) slidably mounted on the frame for making the subframe pivot; a drive unit (5) including a spindle motor (52) for rotating an optical disc, an optical pickup (53), and a feeding mechanism (54) adapted to move the optical pickup for reading/recording information; and a pair of elastic elements (45) located between the subframe and the drive unit for reducing vibration thereof.

### BACKGROUND OF THE INVENTION

1. Field of the Invention

The present invention generally relates to an optical disc drive which can effectively reduce the vibration and noise produced by a drive unit thereof.

2. Description of Related Art

Optical disc drives are widely used in personal computers and in entertainment equipment such as DVD (Digital Video Disc) players. Generally, an optical disc received inside an optical disc drive is rotated by a drive unit, and an optical pick-up device moves along the radial direction of the optical disc to read a data stream recorded therein. If the optical disc does not rotate evenly, the optical disc drive is liable to vibrate and generate noise. Excessive vibration may even interfere with the correct operation of the optical pick-up. Therefore, measures must be taken to efficiently reduce the vibration of the drive unit.

A typical example of a vibration-reducing configuration is disclosed in U.S. Pat. No. 4,922,478. Supporting elements are provided and arranged to reduce vibration of the drive unit in an optical disc drive. The supporting elements have helical springs. The springs elastically support the drive unit, reduce the vibration of the drive unit, and reduce noise accordingly. However, the supporting elements are only used to reduce vibration in vertical directions, and are not capable of reducing vibration in horizontal directions. The drive unit is liable to vibrate in horizontal directions. This not only produces noise, but may even lead to the optical disc being damaged.

### SUMMARY OF THE INVENTION

Accordingly, an object of the present invention is to provide an optical disc drive which can reduce vibration of a drive unit thereof in horizontal directions, and thereby effectively reduce or eliminate associated noise.

Another object of the invention is to provide an optical disc drive which reduces vibration between a subframe and a frame thereof, especially during loading and unloading of an optical disc.

In order to achieve the objects set out above, an optical disc drive of the present invention comprises: a frame; a U-shaped subframe pivotably mounted on the frame; a slider slidably mounted on the frame for making the subframe pivot; a drive unit comprising a spindle motor for rotating an optical disc, an optical pickup, and a feeding mechanism adapted to move the optical pickup for reading/recording information; and a pair of elastic elements located between the subframe and the drive unit for reducing vibration thereof.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of an optical disc drive in accordance with the present invention;

FIG. 2 is similar to FIG. 1, but viewed from another aspect;

FIG. 3 is a further exploded view of FIG. 2, but not showing a tray of the optical disc drive;

FIG. 4 is an enlarged view of a circled portion IV of FIG. 3;

FIG. 5 is similar to FIG. 3, but viewed from another aspect; and

FIG. 6 is a cross-sectional view taken along line VI-VI of FIG. 1.

### DETAILED DESCRIPTION OF THE INVENTION

Reference will now be made to the drawing figures to describe the preferred embodiment of the present invention in detail.

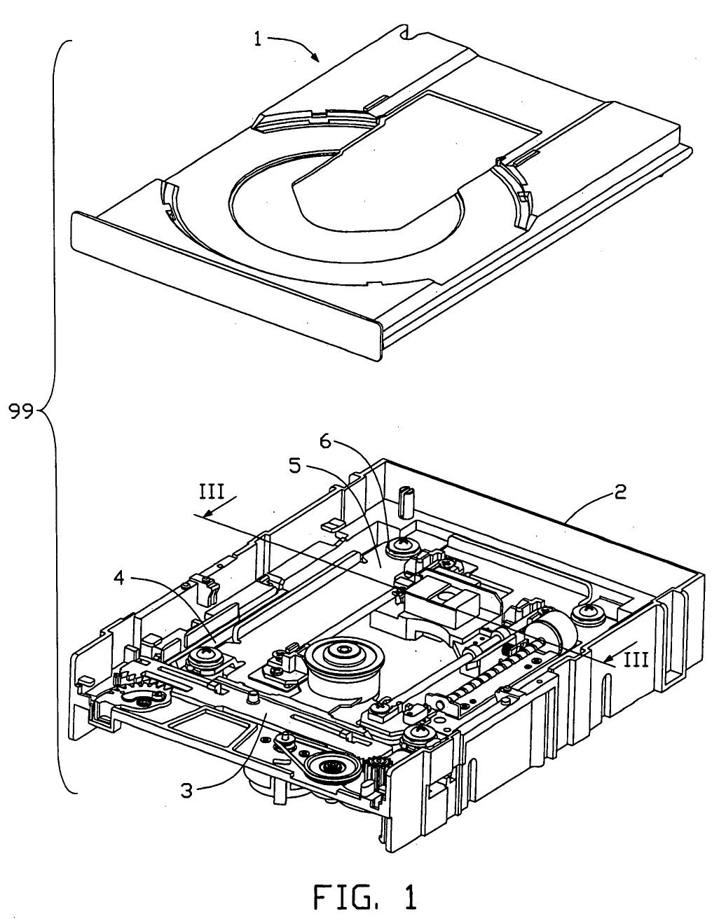

As shown in FIG. 1, an optical disc drive 99 in accordance with the present invention includes a tray 1, a frame 2, a slider 3, a U-shaped subframe 4, a drive unit 5 and four dampers 6. The tray 1 can slide into and out from the frame 2.

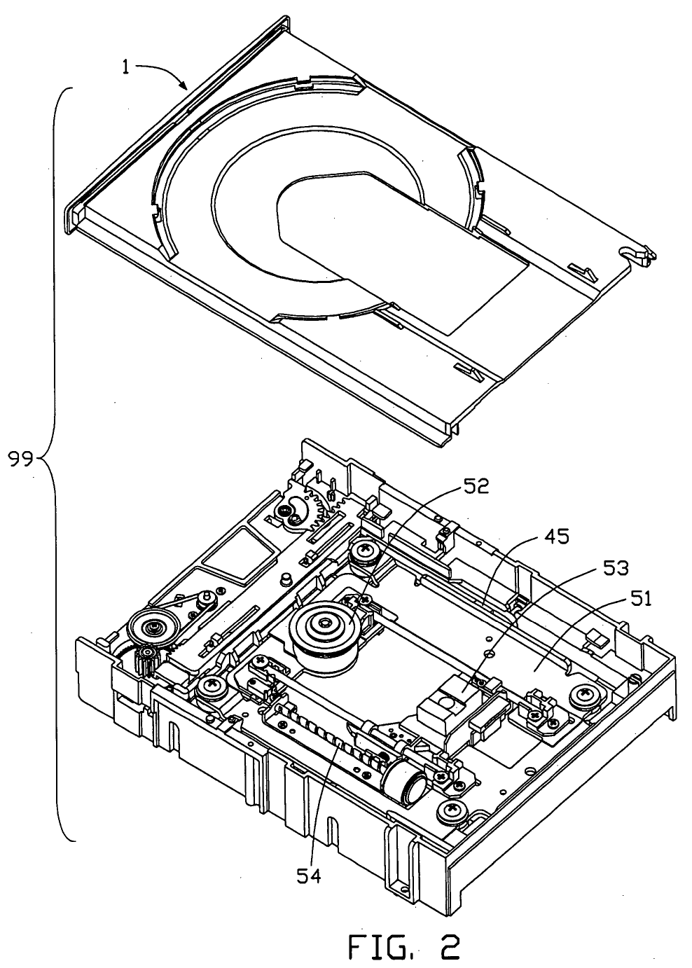

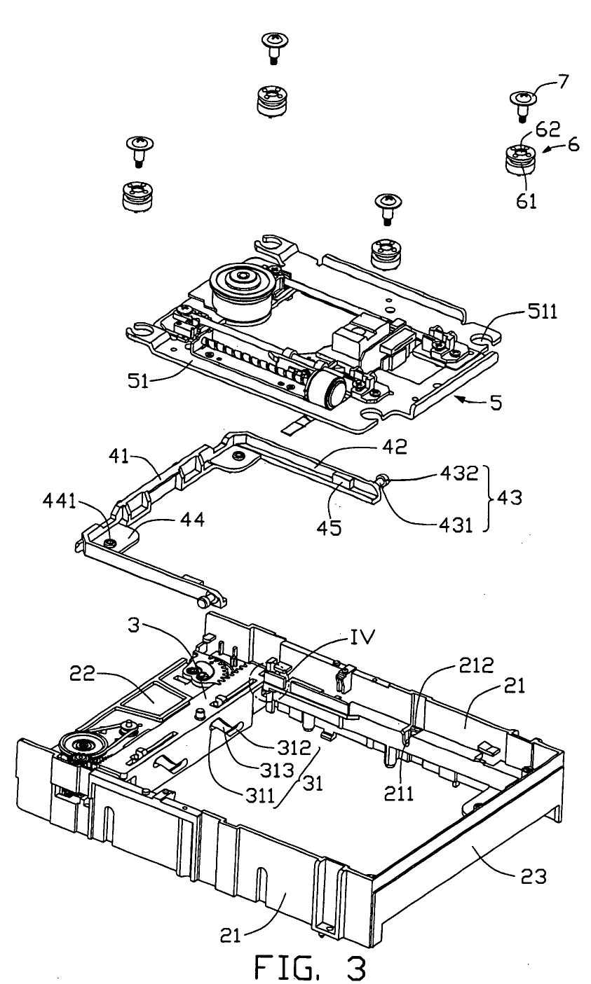

Referring to FIGS. 2 and 3, the drive unit 5 has a supporting plate 51, a spindle motor 52, an optical pickup 53 and a feeding mechanism 54. An optical disc (not labeled) is rotated by the spindle motor 52, and the optical pickup 53 is driven by the feeding mechanism 54 to move along the radial direction of the optical disc so that it reads information recorded in the disc. Four open mounting holes 511 are defined in four comers of the supporting plate 51 respectively.

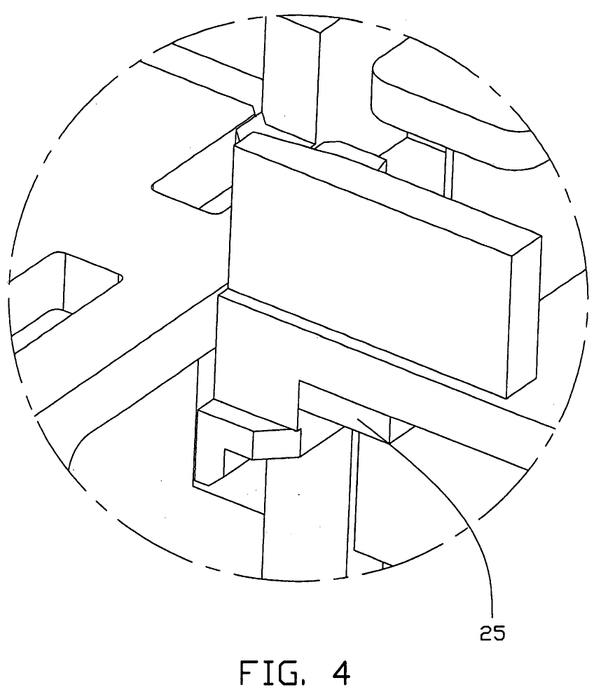

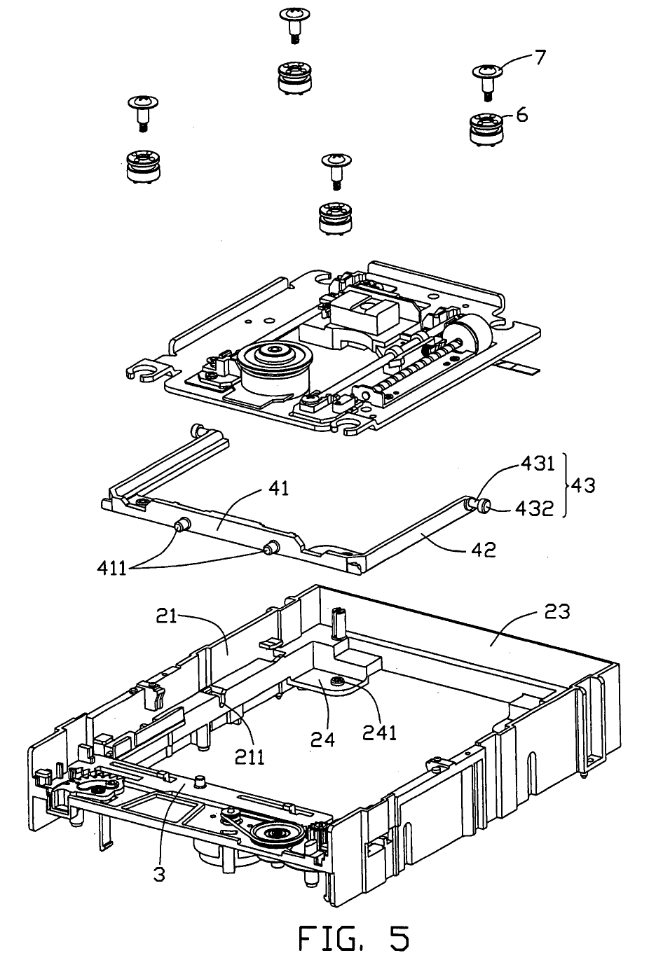

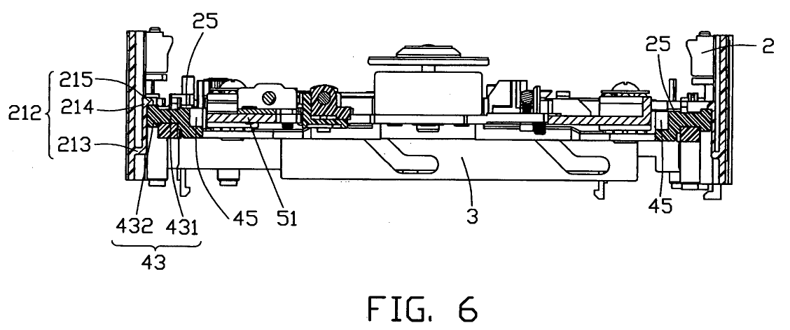

Referring also to FIGS. 5 and 6, the frame 2 is rectangular and hollow. The frame 2 comprises a pair of opposite side walls 21, which are interconnected by a front beam 22 and by a back beam 23. A U-shaped recess 211 is defined in a middle of each side wall 21. An elastic arm 212 is formed on each side wall 21 at each recess 211. The elastic arm 212 extends from an outer side of the recess 211 into the recess 211. The elastic arm 212 comprises a fixed portion 213 and a movable portion 214. The movable portion 214 comprises a claw 215 at an upper end thereof. A first elastic sponge 25 is fixed at each of junctions of the front beam 22 and the two side walls 21 (see especially FIG. 4). A platform 24 is formed at each of junctions of the back beam 23 and the two side walls 21. A screw hole 241 is defined in each platform 24.

The slider 3 is movably mounted on the front beam 22 of the frame 2. Two parallel Z-shaped slots 31 are defined in the front beam 22. Each Z-shaped slot 31 comprises a higher slot portion 311, a lower slot portion 312, and a slant slot portion 313 intercommunicating between the higher slot portion 311 and the lower slot portion 312.

The U-shaped subframe 4 comprises a crossbeam 41, two parallel side beams 42 connecting with opposite ends of the crossbeam 41 respectively, and two extended ends 43 extending perpendicularly outwardly from the free ends of the side beams 42 respectively. The extended ends 43 are accommodated in the recesses 211. Each extended end 43 comprises a cylindrical pivot portion 431, and a cylindrical clamping portion 432 at a distal end of the pivot portion 431. A cross section of the clamping portion 432 is larger than that of the pivot portion 431. Two guide pins 411 extend from an outside surface of the crossbeam 41, for being slidably received in the Z-shaped slots 31 of the slider 3. A platform 44 is formed at each of junctions of the crossbeam 23 and the two side beams 42. A screw hole 441 is defined in each platform 44. A second elastic sponge 45 is fixed on an inside surface of each side beam 42.

The dampers 6 are made of elastic rubber. Each damper 6 defines a central through hole 62, and an external annular groove 61. The annular groove 61 enables the damper 6 to be deformably accommodated in a corresponding mounting hole 511.

In assembly of the optical disc drive 99, the guide pins 411 of the U-shaped subframe 4 are inserted into the Z-shaped slots 31. The extended ends 43 of the U-shaped subframe 4 are pivotably mounted to the frame 2. In particular, the pivot portions 431 of the extended ends 43 are received in the recesses 211, and the claws 215 of the elastic arms 212 hold the extended ends 43 and prevent the extended ends 43 from accidentally coming out from the recesses 211. Further, the elastic arms 212 clamp the clamping portions 432, thereby preventing the U-shaped subframe 4 from moving in directions parallel to the crossbeam 41. The dampers 6 are deformably engaged in the mounting holes 511 of the supporting plate 51. Four screw bolts 7 are respectively passed through the through holes 62 of the dampers 6 and engaged in the screw holes 441 of the U-shaped subframe 4 and the screw holes 241 of the frame 2. Thus, the front of the drive unit 5 is fixed on the platforms 44 of the U-shaped subframe 4, and the back of the drive unit 5 is fixed on the platforms 24 of the frame 2. As a result, the drive unit 5 is located between the second sponges 45 of the side beams 42. Lastly, the tray is inserted into the frame 2.

In operation, the slider 3 slides left/right along the front beam 22 as the tray 1 slides into/out from the frame 2. When the slider 3 slides to the left end of the front beam 22 (as viewed from a front of the optical disc drive 99), the pins 411 of the U-shaped subframe 4 are in the lower slot portions 312. Conversely, when the slider 3 slides to the right end of the front beam 22 (as viewed from the front of the optical disc drive 99), the guide pins 411 of the U-shaped subframe 4 slide along the Z-shaped slots 31 into the higher slot portions 311. As the slider 3 moves from left to right and from right to left, the U-shaped subframe 4 can pivot about the extended ends 43 correspondingly. That is, the drive unit 5 can rise or fall together with the U-shaped subframe 4. The first elastic sponges 25 at the junctions of the front beam 22 and the side walls 21 reduce the clearance between the U-shaped subframe 4 and the frame 2. The first elastic sponges 25 thus reduce any vibration of the U-shaped subframe 4, especially during loading and unloading of the optical disc. The dampers 6 can reduce the vibration of the drive unit 5 in vertical directions. The second elastic sponges 45 can reduce the vibration amplitude of the drive unit 5 in horizontal directions, thus reducing any noise caused by vibration of the drive unit 5.

In alternative embodiments, the first elastic sponges 25 can instead be attached on the U-shaped subframe 4. As long as the first elastic sponges 25 are placed between the U-shaped subframe 4 and the frame 2, vibration occurring during loading and unloading of the optical disc can be reduced. Similarly, the second elastic sponges 45 can instead be attached on side surfaces of the drive unit 5. As long as the second elastic sponges 45 are placed between the U-shaped subframe 4 and the drive unit 5, vibration of the drive unit 5 can be reduced. Furthermore, the first elastic sponges 25 and the second elastic sponges 45 can be devices or materials other than elastic rubber. For example, the first and second elastic sponges 25, 45 may instead be springs, or may comprise another kind of elastic material such as an elastomer.

Although the present invention has been described with reference to specific embodiments, it should be noted that the described embodiments are not necessarily exclusive, and that various changes and modifications may be made to the described embodiments without departing from the scope of the invention as defined by the appended claims.

1. An optical disc drive, comprising:
a frame;
a subframe with two ends pivotably mounted on said frame;
a slider slidably mounted on said frame for making said subframe pivot;
a drive unit comprising a spindle motor for rotating an optical disc, an optical pickup, and a feeding mechanism adapted to move the optical pickup for reading/recording information; and
at least one elastic element located between the subframe and the drive unit for reducing vibration thereof.

2. The optical disc drive as recited in claim 1, wherein the subframe comprises a crossbeam and a pair of side beams interconnected by the crossbeam.

3. The optical disc drive as recited in claim 2, wherein the drive unit is located between the side beams of the subframe, and the at least one elastic element is attached on an inside surface of at least one of the side beams.

4. The optical disc drive as recited in claim 3, wherein the at least one elastic element is an elastic sponge.

5. The optical disc drive as recited in claim 2, wherein two ends respectively extend from outsides of the side beams.

6. The optical disc drive as recited in claim 5, wherein each of the ends comprises a cylindrical pivot portion, and a clamping portion having a cross section larger than that of the pivot portion.

7. The optical disc drive as recited in claim 6, wherein two recesses are formed in the frame.

8. The optical disc drive as recited in claim 7, wherein the frame comprises two elastic arms for preventing the ends of the subframe from accidentally coming out from the recesses.

9. The optical disc drive as recited in claim 8, wherein the pivot portions are received in the corresponding recesses.

10. The optical disc drive as recited in claim 8, wherein each of the elastic arms comprises a fixed portion connecting with the frame, and an upwardly extending movable portion having a claw.

11. The optical disc drive as recited in claim 1, further comprising at least another elastic element located between the frame and the subframe.

12. The optical disc drive as recited in claim 11, wherein the at least another elastic element is an elastic sponge.

13. An optical disc drive, comprising:
a frame with a moveable subframe thereon;
a slider slidably mounted on said frame for making said subframe move;
a drive unit comprising a spindle motor for rotating an optical disc, an optical pickup, and a feeding mechanism adapted to move the optical pickup for reading/recording information; and
at least one elastic element located between the subframe and the drive unit for reducing vibration thereof.

14. An optical disc drive, comprising:
a frame with a moveable subframe thereon;
a slider slidably mounted on said frame for making said subframe move;
a drive unit comprising a spindle motor for rotating an optical disc, an optical pickup, and a feeding mechanism adapted to move the optical pickup for reading/recording information; and
at least one elastic element located adjacent to at least one of the subframe and the drive unit for reducing vibration thereof.
